(19) United States
(12) Patent Application Publication
(10) Pub. No.: US 2002/0101962 A1
(43) Pub. Date: Aug. 1, 2002

(54) Paging answering device

(76) Inventors: Hsi-Che Lee, Taipei (TW); Tung-Hsing Pan, Taipei (TW); Mei-Jiuan Chan, Taipei (TW)

Correspondence Address: JOCOBSON, PRICE, HOLMAN & STERN, PROFESSIONAL LIMITED LIABILITY COMPANY, 400 Seventh Street, N.W., Washington, DC, 20004, US

(21) Appl. No.: 09/772,995

(22) Filed: Jan. 31, 2001

(51) Int. Cl. H04M 1/64

(52) U.S. Cl. 379/67.1

(57) ABSTRACT

A paging answering device composed of an answering device that connects to a telephone set, including a transmit and decoding interface, a central processing unit, a memory, a voice IC, a ringing circuit and an amplifier circuit. For any incoming call, the caller is required to enter a code that represents the person who is wanted. The code entered would be compared to the codes preset in the memory. If the codes match, the voice IC plays a paging message through a speaker to call aloud for the designated person. If the codes do not match, or no code is entered, the voice message left by the caller would be directly played aloud by the voice IC through the amplifier circuit and the speaker. If no one answers the phone, the call would be ended automatically after a preset period of time so that there will not be calls left unanswered or calls answered simultaneously by more than one person.

### BACKGROUND OF THE INVENTION

I. Field of the Invention

This invention relates generally to a paging answering device and, more specifically, to an answering device connected to a telephone set that identifies the person who is wanted to answer a given incoming call and is able to page this person by playing aloud a voice message or ringing sounds so that incoming phone calls can be directly referred to the designated person. The call will be ended automatically if no one comes to get the phone or for some reason the call does not have to be answered.

II. Description of the Prior Art

Heretofore, it is known to have a telephone line shared by family members living in the same household. A telephone line shared by more than one person typically has the disadvantage that whenever the phone rings, all the persons are urged to answer the call, which is especially disturbing for households having family members who usually have phone calls a lot more than others, such as teenagers or salespersons. Whenever the phone rings, everyone in the household is either trying to answer the phone or unwilling to get the call, which inevitably results in annoying moments of daily life.

It is also known that people need to screen incoming calls when they are unable to get to the phone or trying to avoid specific callers. A typical way of call screening is to have other family members answer the call; however, a person has to pick up the phone anyway when there is no other person at home, even if they cannot identify the caller, and this can be disturbing as well.

The present invention improves on the heretofore known telephone by providing a paging answering device that is to be connected to a telephone set. The paging answering device comprises a transmit and decoding interface, a central processing unit, a memory, a voice IC, a ringing circuit and an amplifier circuit. The transmit and decoding interface receives and sending signals, such as transmitting signals to the central processing unit. The memory stores codes, with each of them representing a specific person. The voice IC records and plays voice messages through a speaker that is connected to an amplifier circuit. Also, the ringing circuit plays artificial sounds through the amplifier circuit and the speaker.

For any incoming call, the paging answering device asks the caller to enter the code for the person to answer the call. The entered code will be compared with the codes stored in the memory. If the codes match, the voice IC plays a paging message through the speaker to call aloud for the designated person. If no code is entered, or the codes do not match, the voice message left by the caller will be played directly through the speaker to page the designated person. Under the situation that no one comes to answer the phone, the call will be ended automatically.

### SUMMARY OF THE INVENTION

It is therefore a primary object of the invention to provide a telephone set with an answering device, able to refer callers directly to the person they are calling for and to play a voice message or ringing sounds to page the designated person.

Another quality that the present invention is desired to simulate is to automatically end a call when there is no one available to answer the phone call or when the call does not have to be answered. The present invention prevents the situation under which people in the house or the office are all urged to pick up the phone or, on the other hand, all unwilling to answer the call. Therefore, with the present invention, there will not be calls left unanswered or calls answered simultaneously by more than one person.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a circuit block diagram of the present invention.

FIG. 2 is a flow chart of the present invention.

FIG. 3 is a circuit block diagram of another embodiment of the present invention.

FIG. 4 is a flow chart of another embodiment of the present invention.

### DESCRIPTION OF THE PREFERRED EMBODIMENT

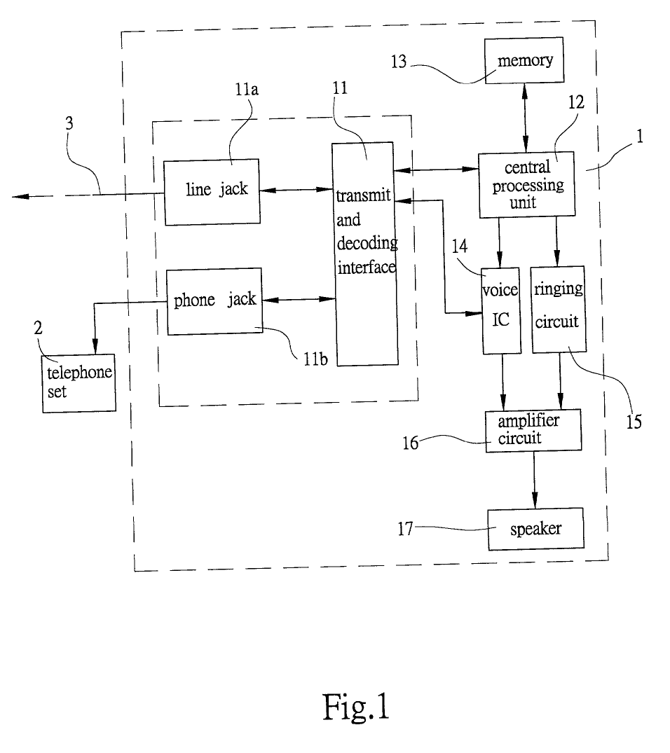

First, refer to FIG. 1, the present invention is composed of an answering device 1 connected to a telephone set 2. The answering device 1 includes:

a transmit and decoding interface 11, linked to the telephone set 2 and the telephone line 3, used for sending and receiving signals;

a central processing unit 12, connected to the transmit and decoding interface 11, controlling internal circuit and signal;

a memory 13, connected to the central processing unit 12, able to record a plurality of code; a voice IC 14, connected to the central processing unit 12 and the transmit and decoding interface 11, recording and playing voice messages;

a ringing circuit 15, connected to the central processing unit 12, playing artificial sounds and an amplifier circuit 16, connected to the voice IC 14, the ringing circuit 15, and a speaker 17, amplifying the output from the voice IC 14 or the ringing circuit 15, which is then played aloud through the speaker 17.

According to the construction described above, the telephone line 3 should be plugged into the line jack 11a on the answering device 1, and the cable of the telephone 2 should be connected to the phone jack 11b on the answering device 1.

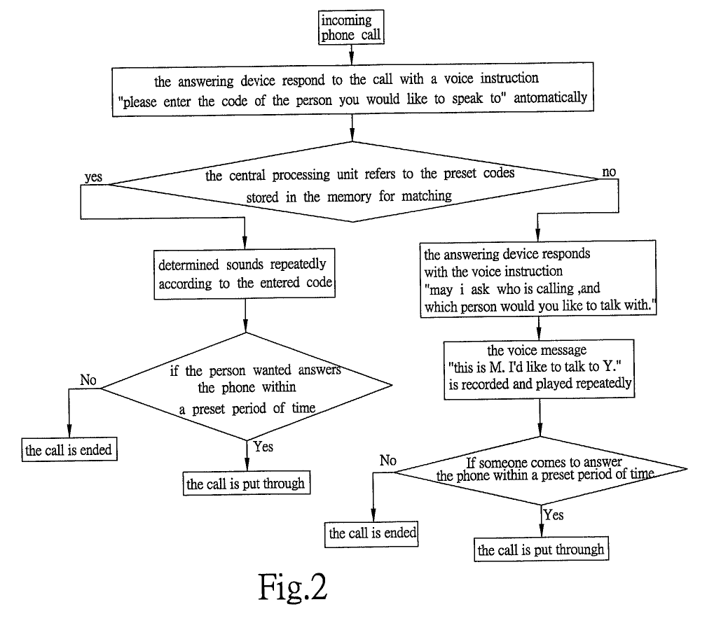

For any incoming call, the working procedure of the answering device 1 is shown in FIG. 2. The central processing unit 12 makes the voice IC 14 respond to the call with a voice instruction “please enter the code of the person you would like to speak to” through the transmit and decoding interface 11. The answering device 1 will then wait for a response from the caller. If a code is entered by the caller, the central processing unit 12 refers to the preset codes stored in the memory 13 for matching. If the codes match, the central processing unit 12, based on the entered code, makes the voice IC 14 play pre-determined sounds repeatedly to call for the designated person. The person who is wanted by the caller is supposed to answer the phone. If no one comes to answer the phone within a preset period of time, or during which the caller hangs up, the call is ended automatically.

If the answering device 1 does not receive a code or receive a code that does not match any of the preset ones in the memory, the central processing unit 12 prompts the voice IC 14 to respond with another voice instruction “may I ask who is calling, and which person would you like to talk with.” The caller may respond with “this is M. I'd like to talk to Y” Upon receiving this voice message, the central processing unit 12 of the answering device 1 makes the voice IC 14 record this message and directly play aloud the voice message through the amplifier circuit 16 and the speaker 17. Similarly, the ringing circuit 15 intermittently plays ringing sounds through the amplifier circuit 16 and the speaker 17. If no one comes to answer the phone within a preset period of time, or during which the caller hangs up, the call is ended.

The automatic paging function of the present invention prevents the situation under which no one is willing to answer phone calls or more than one person gets to the phone simultaneously.

The paging message used to call for the designated person can be a pre-recorded sound of the person's name or title, or any other artificial sounds saved as defaults in the voice IC 14. The artificial sounds can be a variety of simulated sounds, such as bell ringing, music tempo, animal sounds, etc. A paging message for a given person can be presented by an exclusive sound so that people can determine who should be answering the call by the sounds.

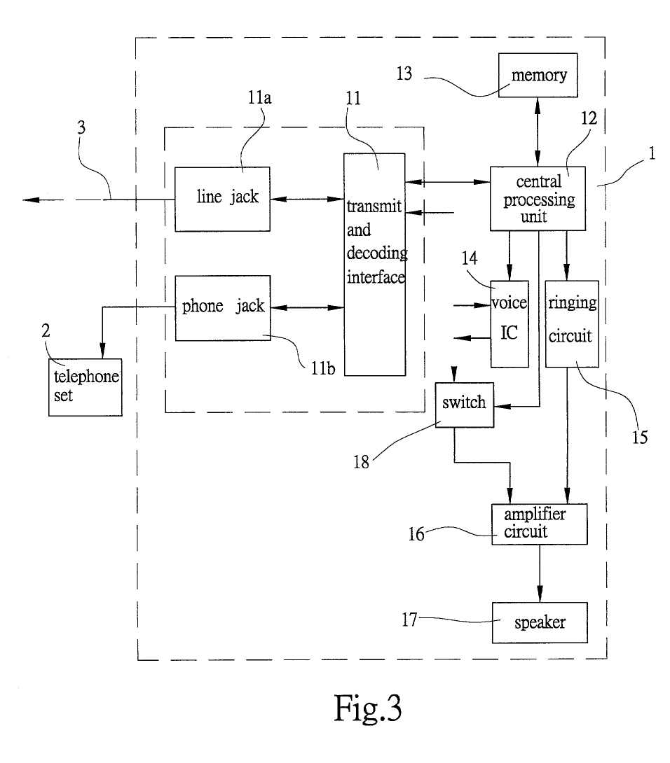

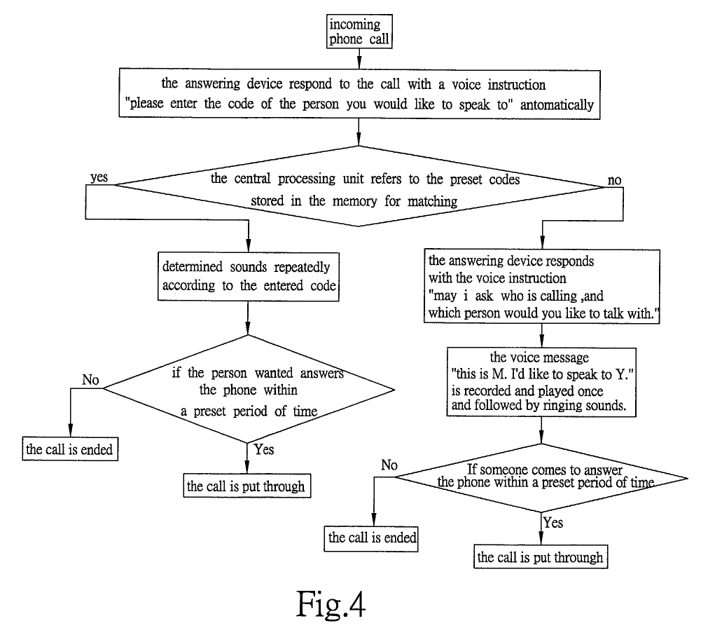

Refer to FIG. 3, the voice IC 14 can be linked to a switch 18 that connects to the central processing unit 12 and the amplifier circuit 16. When the answering device 1 receives no codes or codes failing to match the preset ones in the memory, the system would undergo the procedures shown in FIG. 4: The preset program in the central processing unit 12 makes the voice IC 14 respond with a voice instruction “may I ask who is calling, and which person would you like to speak to?” When the caller responds with “this is M. I'd like to speak to Y.” the central processing unit 12 plays this message through the amplifier circuit 16 and the speaker 17. Then the central processing unit 12 makes the switch 18 discontinue the signals from the voice IC 14 and then also makes the ringing circuit 15 play ringing sounds. In other words, the voice message “this is M. I'd like to speak to Y” would be played only once and followed by ringing sounds.

As another application of the present invention, the answering device 1 can be installed as part of the inner circuit of the telephone set 2 so that the answering device 1 and the telephone set 2 become a single device.

While only one embodiment of the present invention has been shown and described, it will be understood that various modifications and changes could be made thereunto without departing from the spirit and scope of the invention disclosed.

What is claimed is:

1. A paging answering device mainly includes an answering device connected to a telephone set, wherein said answering device comprising:
a transmit and decoding interface, linked to said telephone set and a telephone line, used for sending and receiving signals;
a central processing unit, connected to said transmit and decoding interface, controlling internal circuit and signal transmitting;
a memory, connected to said central processing unit, able to record an even number of codes;
a voice IC, connected to said central processing unit and said transmit and decoding interface, recording and playing voice messages;
a ringing circuit, connected to said central processing unit, playing artificial sounds and an amplifier circuit, connected to said voice IC, said ringing circuit, and a speaker, amplifying the output from said voice IC or said ringing circuit, which is then played aloud through said speaker.

2. A paging answering device as claimed in claim 1, wherein said voice IC can be linked to a switch that connects to said central processing unit and said amplifier circuit.

3. A paging answering device as claimed in claim 1, wherein said answering device can be integrated into said telephone set so that said answering device and said telephone set become a single device.
